(19) United States
(12) Patent Application Publication
(10) Pub. No.: US 2022/0396971 A1
(43) Pub. Date: Dec. 15, 2022

(54) A LOCK CONFIGURED TO BE OPERATED BY A KEY

(71) Applicant: UrbanAlps AG, Zürich (CH)

(72) Inventors: Jirí HOLDA, Jaromer (CZ); Alejandro OJEDA, Baden (CH)

(21) Appl. No.: 17/609,025

(22) PCT Filed: May 12, 2020
(86) PCT No.: PCT/EP2020/063217

§ 371 Date: Nov. 5, 2021

(30) Foreign Application Priority Data
May 17, 2019 (EP) 19175228.6

(51) Int. Cl. E05B 15/08; E05B 29/00; E05B 35/00; E05B 19/00

(52) U.S. Cl. CPC E05B 15/08; E05B 29/0013; E05B 35/001; E05B 19/0047; E05B 29/0066

(57) ABSTRACT

A lock configured to be operated by a key, which includes a key shank, which at least in a part of its axial length includes a profile which is closed or semi-closed to define at least one cavity including a key coding. The lock includes a plug for receiving the key shank. The plug is rotatable with respect to a housing in the unlocked state of the lock and includes a keyway, which is defined by a predetermined geometry. At least one keyway shaping element is provided, which is formed separate from the plug and is fixed to the plug such that it is immovable relative to the plug when the key shank is inserted into the plug. A protruding portion of the at least one keyway shaping element protrudes into the keyway to redefine its geometry.

The present invention relates to a lock configured to be operated by a key with a key shank, which includes at least in a part of its axial length a profile which is closed or semi-closed to define at least one cavity including a key coding.

Such locks are e.g. known from U.S. Pat. No. 9,920,548 B2, WO 2016/162363 A1 and WO 2018/041277 A1 of the same applicant.

The uniqueness of a lock is defined by a number of specific characteristics. This number is limited so that a limited number of unique locks can be provided. It is desirable to increase the number in a simplified manner.

It is an object of the present invention to refine the existing locks such that an increased variety of unique configurations are possible.

For solving this object, a lock according to claim 1 is provided. Also, a lock system according to claim 10 and a method for manufacturing a lock according to claim 15 are provided. The further claims specify additional embodiments of the lock and the lock system.

According to claim 1 the lock comprises at least one keyway shaping element, which is formed separate from the plug and which is fixed to the plug such that it is immovable relative to the plug when the key shank is inserted into the plug, wherein a protruding portion of the at least one keyway shaping element protrudes into the keyway to redefine its geometry. This allows the configuration of a larger number of unique locks.

The provision of at least one keyway shaping elements allows also the provision of master and slave locks. A master lock may be e.g. configured as a lock which includes the at least one keyway shaping element and a slave lock may be configured in the same way, but without the at least one keyway shaping element.

There may be provided a master key which is configured to operate the master lock as well as the slave lock, and a slave key which is configured to operate the slave lock only. The master key may e.g. include a wall portion, which, seen in a plane transverse to the longitudinal direction in which the key shank extends, has a shape complementary to the protruding portion of the at least one keyway shaping element. The slave key may e.g. include a wall portion, which, seen in a plane transverse to the longitudinal direction in which the key shank extends, has a shape complementary to the keyway without the at least one keyway shaping element.

There may be provided more than one keyway shaping element. For instance it is conceivable to provide the plug with two or more keyway shaping elements, each being formed separate from the plug and fixed to the plug such that they are immovable relative to the plug when the key shank is inserted into the plug. The protruding portions of the keyway shaping elements protrude into the keyway to redefine its geometry at different locations. The keyway shaping elements may be arranged at the same axial position along the axial direction of the keyway. Accordingly, the geometry of the keyway is redefined at locations, which have the same axial position. In addition to this configuration or alternatively thereto keyway shaping elements may be arranged offset to each other along the axial direction of the keyway. Thereby, the geometry of the keyway is redefined at different axial positions.

Preferably, the at least one keyway shaping element is different from a plate having a U-shaped opening.

The plug for receiving the key shank of the key includes a keyway, which is defined by a predetermined geometry. Preferably, the predetermined geometry has a cross-section which is different from a rectangular shape and/or from a U-shape.

Preferably, the lock according to the invention may comprise a plug which is made of one piece.

Preferably, the geometry of the keyway may be defined in part by the plug and in part by at least one another component, e.g. by a housing in which the plug is to be accommodated such that it is rotatable in the unlocked state of the lock. Alternatively, the geometry of the keyway may be defined fully by the plug.

Preferably, the key to operate the lock according to the invention may comprise a key shank which is different from a U-shape and/or a flat shape. Preferably, the key shank is free of a flat blade. The profile of the key shank defining the at least one cavity which includes a key coding may include an arcuate wall portion. The profile of the latter may be defined by two opposite side faces, which are arcuate.

Preferably, the key to operate the lock according to the invention may comprises a key shank defined by a rigid hollow key body that includes the at least one coding cavity. The shape of the key body is such that the key coding is at least in part invisible from outside and/or the shape of the key body is different from a U-shape.

Following, further embodiments are described with reference to Figures. In the drawings:

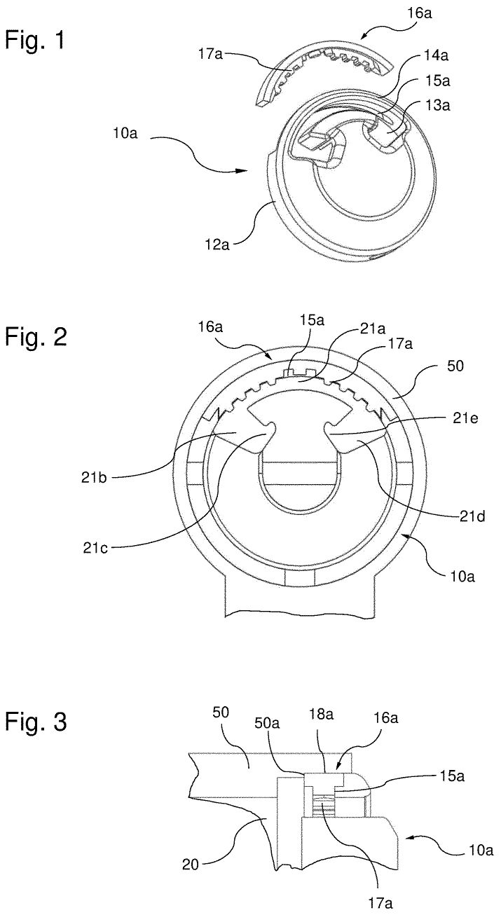

FIG. 1 shows a perspective view of a cap with a keyway shaping element for a lock according to a first embodiment;

FIG. 2 shows a sectioned rear view of the cap and the keyway shaping element of FIG. 1 mounted in a housing;

FIG. 3 shows part of the configuration of FIG. 2 in a sectioned side view;

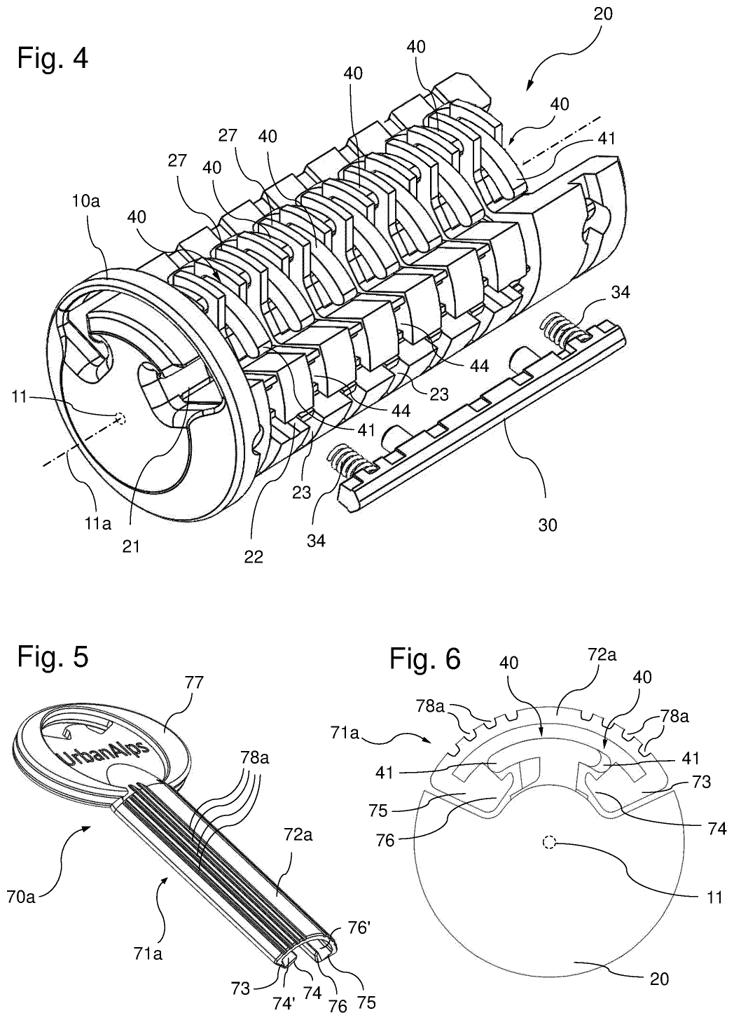

FIG. 4 shows a perspective view of the lock according to the first embodiment, wherein the housing is not shown;

FIG. 5 shows a perspective view of a key operable with the lock according to the first embodiment;

FIG. 6 shows a partially sectioned front view of the configuration of FIG. 4 with the key of FIG. 5 inserted therein;

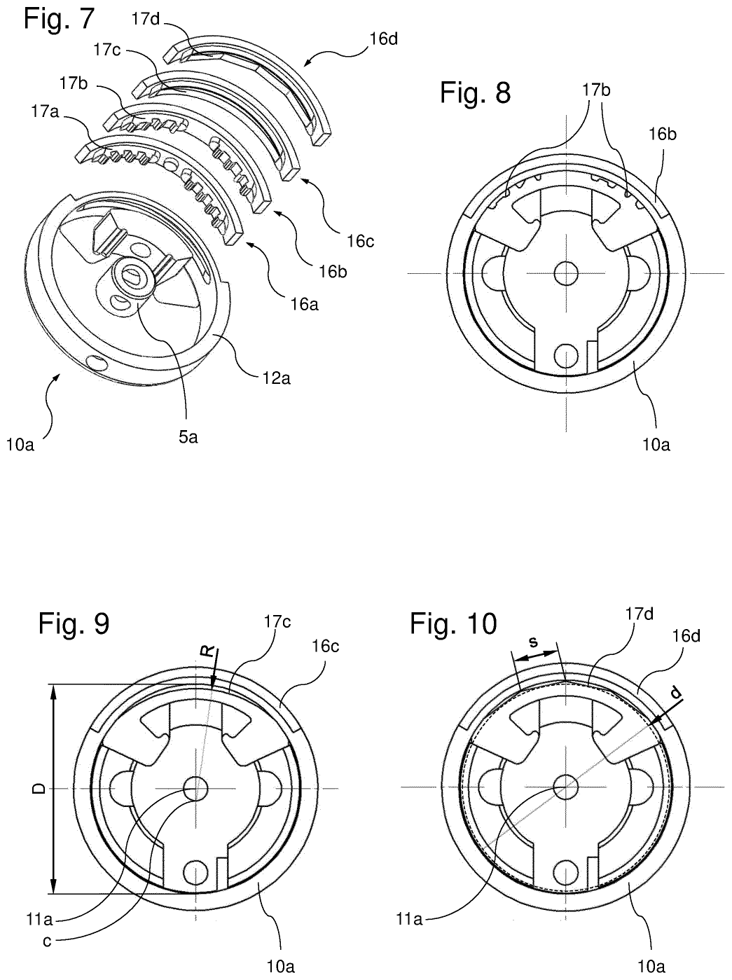

FIG. 7 shows a perspective view of the cap and variants of the keyway shaping elements;

FIG. 8 shows a partially sectioned rear view of a variant shown in FIG. 7 in the assembled state;

FIG. 9 shows a partially sectioned rear view of another variant shown in FIG. 7 in the assembled state;

FIG. 10 shows a partially sectioned rear view of a further variant shown in FIG. 7 in the assembled state;

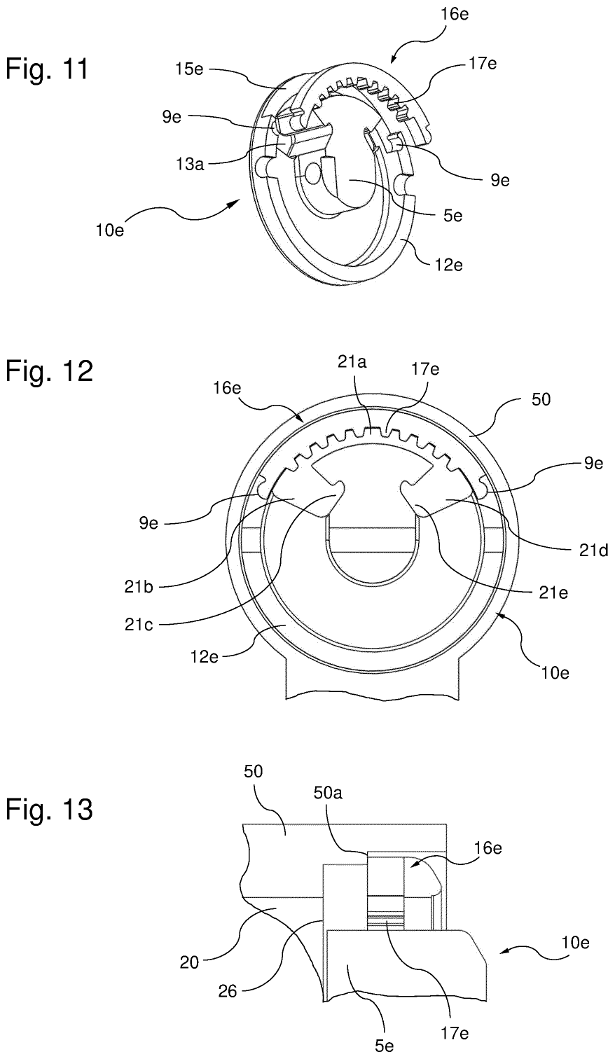

FIG. 11 shows a perspective view of a variant of the cap with a keyway shaping element;

FIG. 12 shows a partially sectioned rear view of the cap and the keyway shaping element of FIG. 11 mounted in a housing;

FIG. 13 shows part of the configuration of FIG. 12 in a sectioned side view;

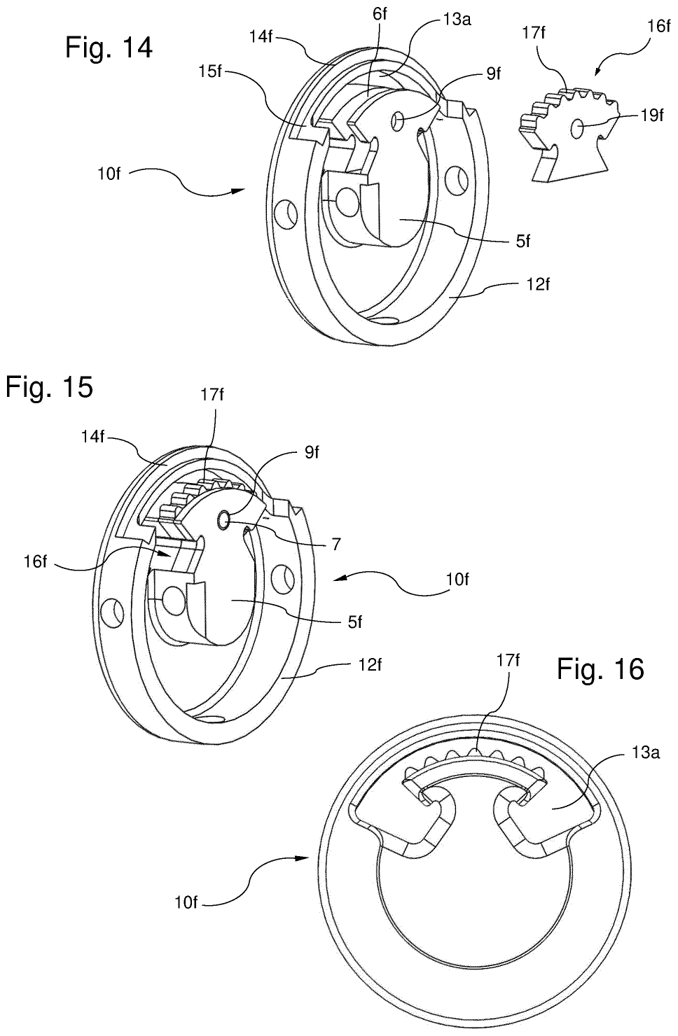

FIG. 14 shows a perspective view of a cap with a keyway shaping element for a lock according to a second embodiment;

FIG. 15 shows the cap with the keyway shaping element of FIG. 14 in the assembled state;

FIG. 16 shows the configuration of FIG. 15 in a front view;

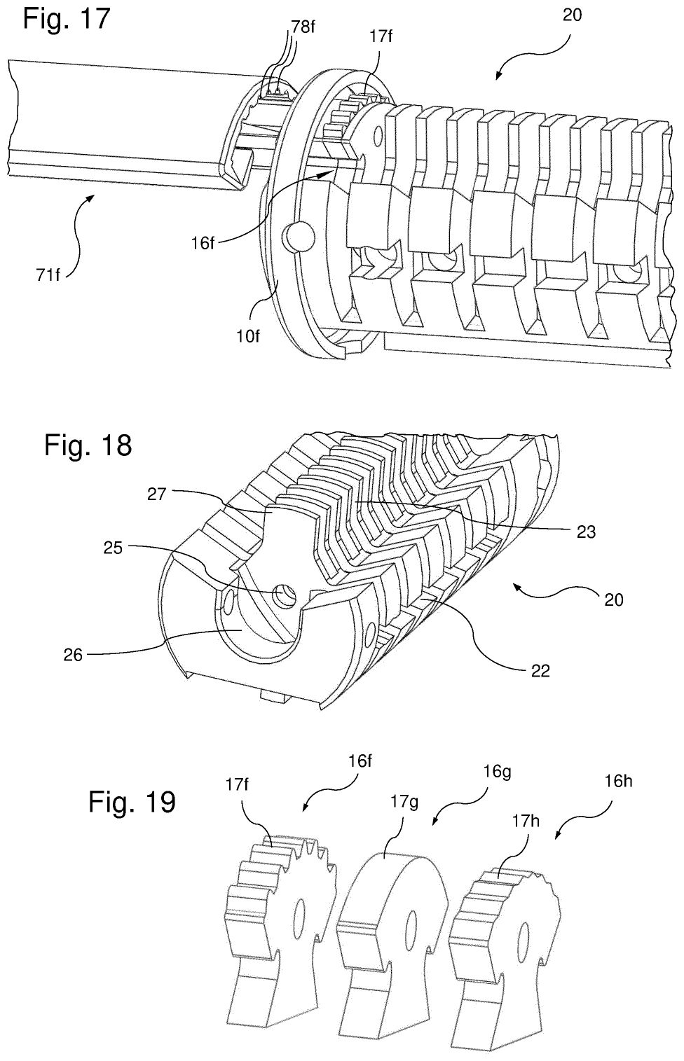

FIG. 17 shows a perspective view of a part of a key and of the lock according to the second embodiment;

FIG. 18 shows part of the plug for the lock of FIG. 17;

FIG. 19 shows variants of the keyway shaping element for the lock according to the second embodiment;

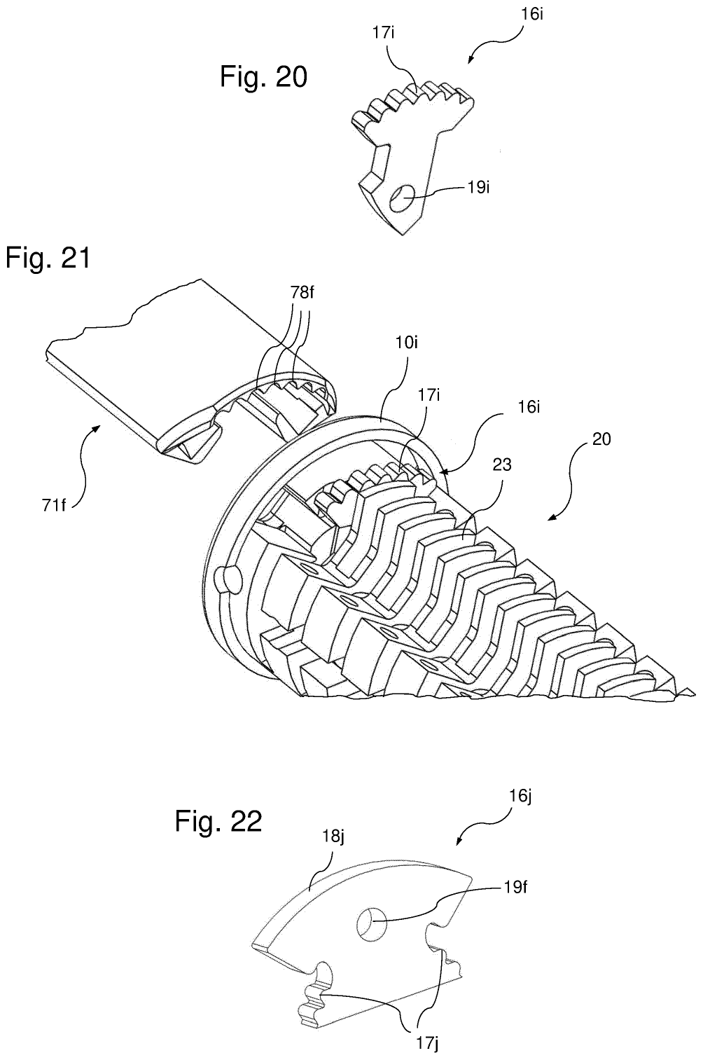

FIG. 20 shows another variant of the keyway shaping element for the lock according to the second embodiment;

FIG. 21 shows a perspective view of a part of a key and of the lock according to the second embodiment including the keyway shaping element of FIG. 20;

FIG. 22 shows another variant of the keyway shaping element for the lock according to the second embodiment;

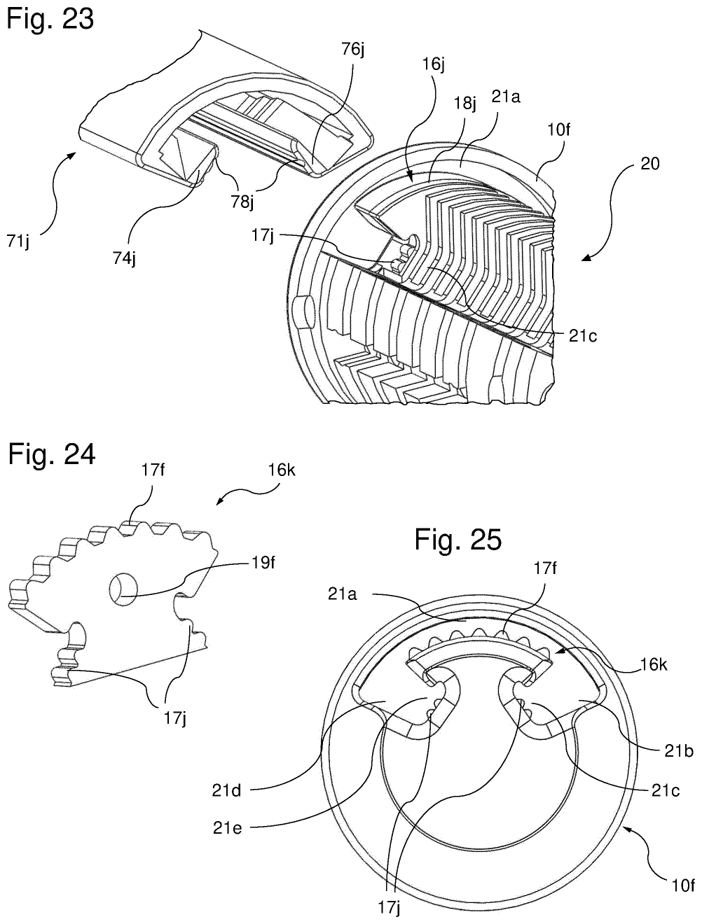

FIG. 23 shows a perspective view of a part of a key and of the lock according to the second embodiment including the keyway shaping element of FIG. 22;

FIG. 24 shows another variant of the keyway shaping element for the lock according to the second embodiment;

FIG. 25 shows a front view of the lock according to the second embodiment including the keyway shaping element of FIG. 24;

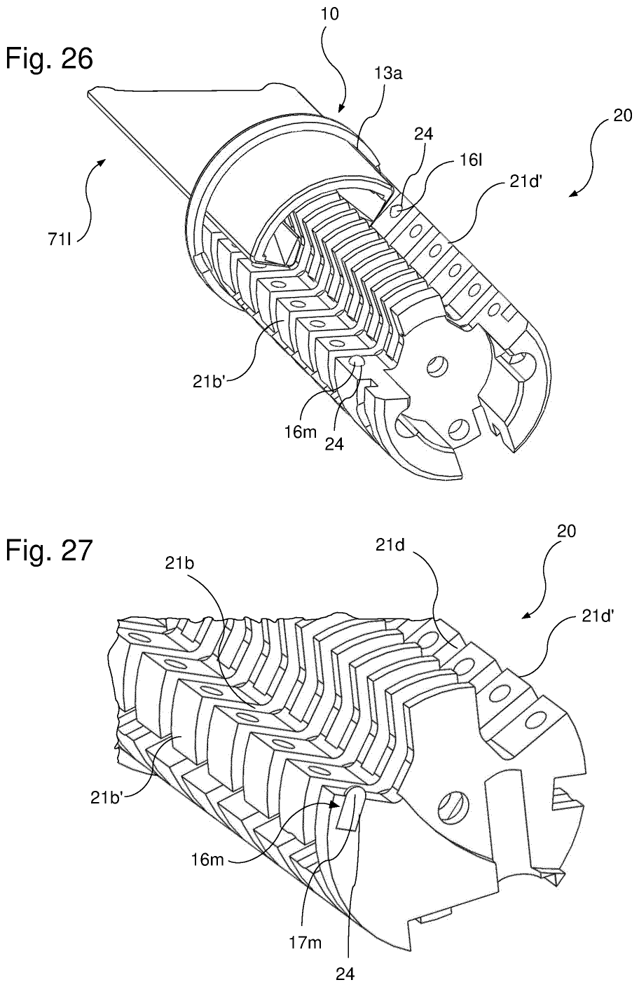

FIG. 26 shows a perspective view of a part of a key and of a lock according to a third embodiment;

FIG. 27 shows a detail of the configuration of FIG. 26, wherein the rearward part is shown in a sectioned view;

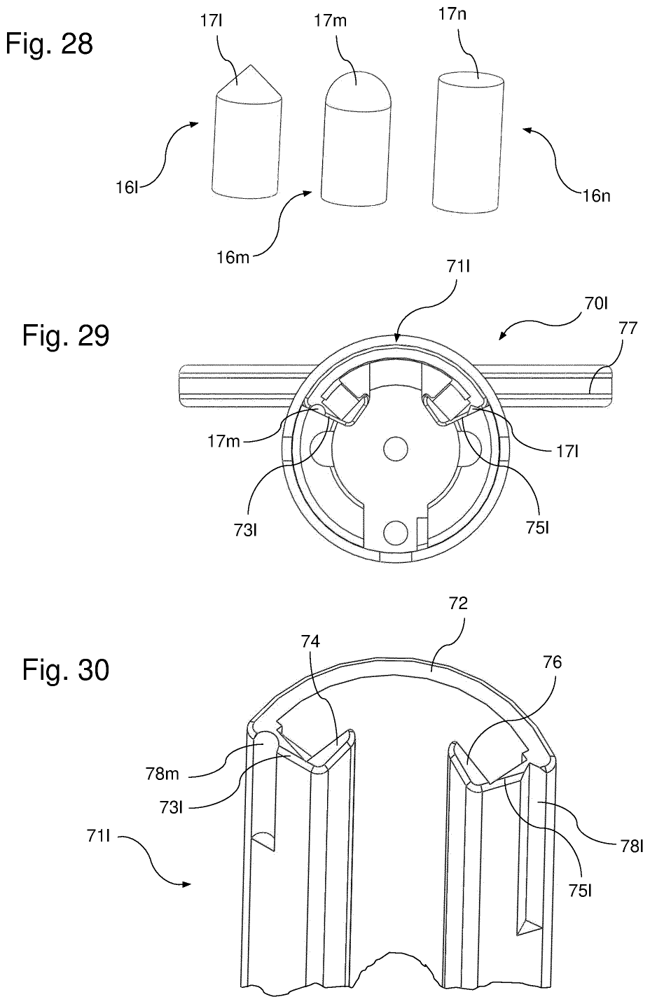

FIG. 28 shows variants of the keyway shaping element for a lock to the third embodiment;

FIG. 29 shows a rear view of the configuration of FIG. 26;

FIG. 30 shows a detail of the key of FIG. 26;

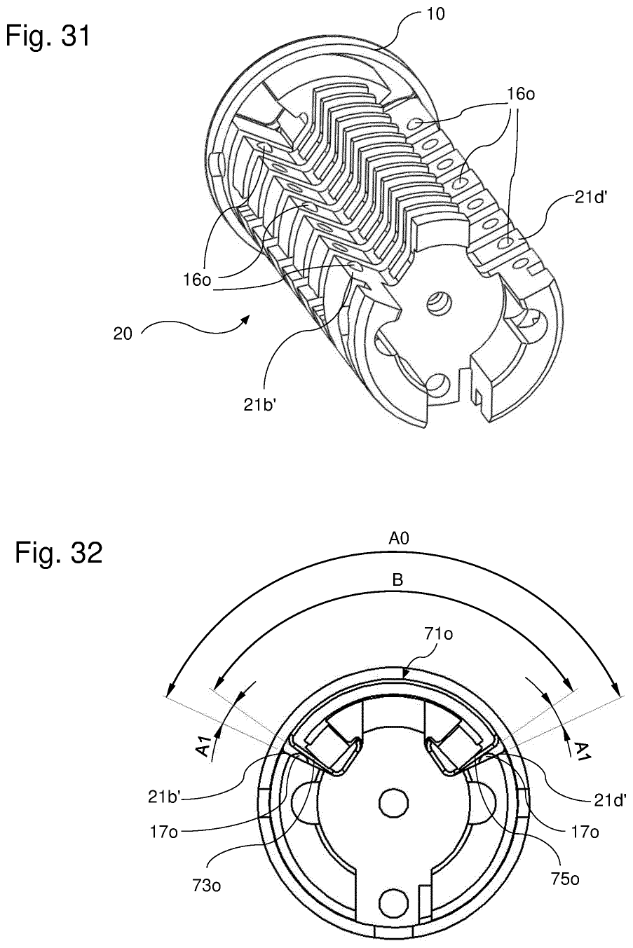

FIG. 31 shows a perspective view of a part of a variant of the lock according to the third embodiment; and

FIG. 32 shows a rear view of the configuration of FIG. 31 together with a key inserted therein.

In general, the embodiments of the lock described hereinafter may comprise the following components:
a plug, which includes a keyway configured to receive a key (see e.g. the plug 20 in FIG. 4),
a housing with a circular cylindrical opening, in which the plug is accommodated (see e.g. the housing 50 in FIG. 2),
one or more blocking bars for preventing a rotation of the plug with respect to the housing when the lock is in the locked state (see the blocking bar 30 in FIG. 4),
one or more validating elements configured to cooperate with a key introduced into the keyway to read a key coding (see e.g. the validating elements 40 in FIG. 4).

The individual embodiments and variants thereof are now described in more detail.

### First Embodiment

FIG. 1 shows a cap 10a, which serves for covering the front end of the plug 20 (see FIG. 4). The cap 10a has a circular cylindrical cross-section and comprises a plate, which is provided at its periphery with an edge element 12a. The cap 10a includes a passage 13a which is part of the keyway. The edge element 12a has a clearance for receiving a keyway shaping element 16a. The latter has the form of a curved ribbon and includes a protruding portion 17a, e.g. in the form of one or more teeth.

At the position of said clearance of the edge element 12a the cap 10a forms an arcuate segment 14a. The latter includes at least one slit 15a which runs alongside of the segment 14a. In the assembled state as shown in FIG. 2, the keyway shaping element 16a is immovably attached to the plug 20 by means of the cap 10a. The protruding portion 17a of the keyway shaping element 16a extends through the slit 15a into the keyway.

The keyway 21 defined in the plug 20 has a predetermined profile when seen in a plane perpendicular to the direction into which a key is introduced into the keyway 21. Here, the profile of the keyway 21 has an arcuate middle portion 21a connecting two side portions 21b, 21d, each of which including a return portion 21c, 21e. The protruding portion 17a of the keyway shaping element 16a redefines said predetermined keyway profile in the plug 20. Here, the protruding portion 17a includes teeth and thus has the effect that the outer side of the middle portion 21a of the keyway 21 is no longer defined by a circular line, but by a serrated curve.

As shown in FIG. 3, the cap 10a is at least partially arranged within the housing 50. The peripheral face 18a of the keyway shaping element 16a is adjacent to the housing 50. The latter includes a step 50a which is adjacent to the rearward side of the keyway shaping element 16a.

FIG. 4 shows an example of a lock including the cap 10a, the plug 20, and the validating elements 40.

The plug 20 comprises a keyway 21, which extends in the insertion direction of the key and which serves for receiving the shank of the key.

The plug 20 is provided with an axle 11 (see also FIG. 6) which extends along a rotation axis 11a and which is attached to the cap 10a. To this end, the cap 10a may be provided with a peg including a hole for receiving the end of the axle 11, see the peg 5a in FIG. 7.

The plug 20 has ribs 27 and slots 23 therebetween, which are arranged transversally to the rotation axis 11a. The validating elements 40 are received in the slots 23 and arranged on the axle 11 in a rotatable manner around the rotation axis 11a. The slots 23 are configured such that a portion of a validating element 40 can cooperate with at least one blocking bar 30.

Each validating element 40 has a first arm 41, which is configured to contact a coding part of a key, and a second arm with a recess 44. Here, the validating elements 40 are arranged in an alternating inverted manner so that the first arms 41 point alternatingly to the left and right side.

The plug 20 includes further a receiving groove 22, which extends alongside of the plug 20 and which serves for receiving the blocking bar 30 in the unlocked state of the lock.

The blocking bar 30 is preloaded such that in the locked state of the lock it is pushed into a longitudinal groove which is formed in the housing 50 (not shown). Said longitudinal groove extends along a longitudinal direction which is arranged parallel to the rotation axis 11a, around which the plug is rotatable with respect to the housing 50 in the unlocked state of the lock. The pushing force is e.g. produced by elastic means, e.g. in the form of one or more springs 34.

In the example of FIG. 4 a second receiving groove is formed in the plug 20 opposite to the groove 22 for receiving a second blocking bar in the unlocked state of the lock. The second blocking bar is preloaded in a similar way as the blocking bar 30 by means of elastic means, so that, in the locked state of the lock, it is pushed into a longitudinal groove formed in the housing 50.

In the locked state of the lock, the blocking bars are arranged between the plug 20 and the housing 50, whereby a rotation of the components including the cap 10a, the plug 20, the blocking bars 30, and the validating elements 40 with respect to the housing 50 is disabled.

When a key with the correct coding is used, then the validating elements 40 and with it the recesses 44 have the correct position, so that the blocking bar 30 can be received in a receiving space formed by recesses 44 of the validating elements 40 and the receiving groove 22 in the plug 20, and in an analogous manner, the second blocking bar can be received in a receiving space formed by recesses 44 of the validating elements 40 and the second receiving groove in the plug 20. Thereby, the blocking bars are released out of the longitudinal grooves in the housing 50 so that the components including the cap 10a, the plug 20, the blocking bars 30, and the validating elements 40 can be rotated relative to the housing 50 around the rotation axis 11a.

FIG. 5 shows an example of the key 70a configured to be used with the lock of FIG. 4. The key 70a has a handling part 77, e.g. a bow, and a key shank 71a extending from the handling part 77 and insertable into the keyway 21 of the lock.

In the present embodiment, the key shank 71a has a semi-closed profile enclosing at least partially the coding part. The key shank 71a has an arcuate middle portion 72a connecting two side portions 73, 75 each being connected to a return portion 74, 76. Thus, the key shank 71a is shaped towards its middle of the key shank 71a, e.g. U-shaped. The portions 73 and 74 as well as the portions 75 and 76 enclose a coding cavity 74′ and 76′, respectively, in which the key coding is formed, e.g. in form of one or more coding tracks. A coding track extends along the key shank 71a and may have e.g. a wavelike course. The coding track may be formed e.g. by a line of successive channel portions and/or ridge portions.

When looking at the key 70a itself, the portions 73-76 prevent that the coding part of the key 70a is visible from outside. This impedes an unauthorized duplication of the key 70a e.g. by producing a copy based on pictures taken from the key 70a.

The outer face of the key shank 71a is adapted to the profile defined by the keyway shaping element 16a. To this end, the outer face of key shank 71a is formed complementary to the protruding portion 17a of the keyway shaping element 16a. Here, the key shank 71a includes grooves 78a for receiving the teeth forming the protruding portion 17a.

When inserting the key 70a into the lock, the teeth of the protruding portion 17a engages into the grooves 78a and the first arm 41 of a validating element 40 protrudes into the coding cavity 74′ or 76′ (see FIG. 6) and follows the coding track of the key 70a formed therein, whereby a validating element 40 is rotated accordingly around the axis 11a. Once the key shank 71a is fully inserted, each validating element 40 and with it its recess 44 have a specific angular position. Said position is such that the blocking bars can enter into the recesses 44 when the key 70a has the correct coding.

FIG. 1 shows one possible example of the protruding portion 17a of the keyway shaping element 16a. A wide variety of shapes are conceivable. Seen in a front view, the protruding portion may include one or more straight portions, one or more curved portions or combinations thereof.

FIG. 7 shows the keyway shaping element 16a together with other examples of the keyway shaping element 16b, 16c, 16d.

As is also apparent from FIG. 8, the protruding portion 17b of the keyway shaping element 16b has teeth which protrude into the keyway 21 formed in the plug 20. The number of the teeth and the shape, in particular the height, as well as the position of each tooth may be arbitrarily chosen.

As is also apparent from FIG. 9, the protruding portion 17c of the keyway shaping element 16c has an arcuate shape. Its form, in particular the length and the curvature, may be arbitrarily chosen. In the example shown in FIG. 9, the parameter D denotes the diameter of the circumcircle which encloses the plug 20, wherein the centre of this circumcircle is on the rotation axis 11a. The protruding portion 17c is defined by a section of a circle with radius R, wherein the centre c of this circle is chosen to be offset to the rotation axis 11a.

As is also apparent from FIG. 10, the protruding portion 17d of the keyway shaping element 16d has a polygonal shape. Its form, in particular the length and the height of a straight section, may be arbitrarily chosen. In the example shown in FIG. 10, the protruding portion 17d is defined by a number of straight sections of length s, which touch the inscribed circle with diameter d and centre on the rotation axis 11a, wherein d<D. The inscribed circle is shown in FIG. 10 as a broken line.

In the examples shown in FIG. 7, the cap 10a and a keyway shaping element 17a-17d are configured such that the latter can be retained axially in the cap 12a. Other configurations are conceivable. FIG. 11 shows an example, in which the keyway shaping element 16e is retained radially in the cap 10e. The edge element 12e has a clearance 15e so that two ends are formed, each having a recess 9e with an undercut shape. The ends of the keyway shaping element 17e is designed complementary to said shape, see also FIG. 12.

Here, the protruding portion 17e of the keyway shaping element 16e has a toothed profile. As with the keyway shaping elements of FIG. 7, the protruding portion 17e of the keyway shaping element 16e may be arbitrarily shaped to redefine the predetermined keyway profile 21a-21e in the plug 20.

The cap 10e has in the middle a protruding element 5e, which defines part of the shape of the keyway 21 and which is received in a recess 26 formed in the plug 20, see FIG. 13. In the assemble state, the rearward side of the keyway shaping element 16e is adjacent to the step 50a in the housing 50.

The keyway shaping elements 16a-16e are e.g. made of metal. The keyway shaping element 16a-16d may be manufactured e.g. by metal injection moulding. The keyway shaping element 16e may be manufactured by machining a piece of raw material, e.g. by laser cutting.

The shank of a key which is useable with a lock having a keyway shaping element 16a-16e has an outer surface which is complementary to the protruding portion 17a-17e. Thus, the shank of the key may have for instance one or more grooves (see grooves 78a in FIG. 5) and/or may have an outer surface defined by one or more curved or straight sections or combinations thereof.

### Second Embodiment

The keyway shaping element 16a-16e cooperate with the outer surface of the key shank. It is possible to configure the keyway shaping element such that it cooperates with the inner surface of the key shank.

FIG. 14 shows a cap 10f with the edge element 12f and a keyway shaping element 16f.

The cap 10f has the passage 13a. A protruding element 5f defining part of the keyway 21 and including a slot 6f is formed in the middle of the cap 10f. The protruding element 5f has a hole 9f going transversally through the slot 6f for receiving the ends of a pin 7 (see FIG. 15).

The keyway shaping element 16f is formed as a plate. It has a protruding portion 17f to redefine the keyway 21 and a through-hole 19f for fixation to the cap 10f.

In the assembled state as shown in FIG. 15, the keyway shaping element 16f is received in the slot 6f and fixed by the pin 7 which goes through holes 9f, 19f. As is also shown in FIG. 16, the protruding portion 17f protrudes into the passage 13a of the cap 10f and thus into the keyway 21.

The edge element 12f in FIGS. 14 and 15 is shown with a clearance 15f, so that the cap 10f forms there an arcuate segment 14f. A keyway shaping element similar to the keyway shaping element 16e may be introduced into the clearance 15f. Thus, different kinds of keyway shaping elements may be arranged in a combined way on the cap 10f. When providing the keyway shaping element 16f only, the clearance 15f may be omitted, so that the edge element 12f extends fully around the protruding element 5f. This configuration is shown in FIG. 17.

Here, the protruding portion 17f of the keyway shaping element 16f has teeth. Accordingly, the inner surface of the key shank 71f has grooves 78f for engagement with the teeth, see FIG. 17. The plug 20 has a recess 26, in which the protruding element 5f can be received, see FIG. 18. This FIG. 18 shows also the central bore 25 in the plug 20 for receiving the axle 11.

Similar as with the keyway shaping elements of FIG. 7, the protruding portion 17f of the keyway shaping element 17f may be arbitrarily shaped to redefine the predetermined keyway profile in the plug 20.

Seen in a front view, the protruding portion may include one or more straight portions, one or more curved portions or combinations thereof. FIG. 19 shows further examples of a keyway shaping element 16g, 16h.

The keyway shaping element 16g has a protruding portion 17g defined by a curved shape. The latter may be defined e.g. by a section of a circle, wherein the centre of this circle is chosen to be offset to the rotation axis 11a, so that the protruding portion 17g protrudes from below into the middle portion 21a of the keyway 21.

The keyway shaping element 16h has a protruding portion 17h with a polygonal shape.

In a further embodiment, the keyway shaping element may also be configured such that it can be placed in a slot 23 of the plug 20 and attached to the axle 11 to which the validating elements 40 are attached. FIG. 20 shows an example of the keyway shaping element 16i, which is formed as a plate. It has a protruding portion 17i, which may be similar to one of the keyway shaping element 17f, and an end with a hole 19i for attachment to the axle 11.

FIG. 21 shows the assembled state, in which the keyway shaping element 16i is received in a front slot formed in the plug 20 and attached to the axle 11 (not visible). The attachment is such that the keyway shaping element 16i is immovably attached to the plug 20 by means of the axle 11. The cap 10i may be configured such that it has a protruding element similar as the protruding element 5e of the keyway shaping 10e. The key 71f with the grooves 78f of FIG. 17 may be used to engage with the teeth of the keyway shaping element 16i.

In FIG. 21 the keyway shaping element 16i is positioned in the foremost slot 23 of the plug 20. It is conceivable that the keyway shaping element 16i is received in another slot 23 of the plug 20 and attached there to the axle 11, so that it is positioned within the axial length of the plug 20.

The length of a groove 78f in the key shank 71f can be chosen in dependency on the position of the keyway shaping element 16i along the plug 20. Thereby, a master and slave lock system may be provided. For instance, a first lock with a keyway shaping element 16i in the foremost slot 23 (in the following “first position”) and a second lock with a keyway shaping element 16i within the axial length of the plug 20 (in the following “second position”) may be provided. A key with grooves sufficiently long so that they extend at least from the first to the second position can open the first and second lock, whereas a key with shorter grooves can open only the second look, but not the first one, since the end of those shorter grooves will abut against the keyway shaping element 16i in the first position, so that the key shank cannot fully be inserted into the keyway.

The keyway shaping element may also be configured such that it redefines another portion of the keyway 21 than its middle portion 21a.

FIG. 22 shows an example of the keyway shaping element 16j, which is formed as a plate having protruding portions 17j at both sides. It has further a hole 19f similar as the keyway shaping element 16f so that it can be fixed by a pin in the slot 6f of cap 10f.

The shape of the upper part 18j of the keyway shaping element 16j corresponds to the lower part of the middle portion 21a of the keyway 21, so that this part 18j does not protrude into the middle portion 21a, see FIG. 23.

The keyway shaping element 16j has on each side a protruding portion 17j protruding into the return portions 21c, 21e of the keyway 21. Here, the protruding portions 17j are formed as one or more teeth. A key useable with the keyway shaping element 16j has a key shank 71j, in which the outer surface of the return portions 74j, 76j have a shape complementary to the protruding portions 17j. Here, the return portions 74j, 76j have grooves 78j for engagement with the teeth of the protruding portions 17j.

Other keyway shaping elements are conceivable to redefine other portions of the keyway 21. FIG. 24 shows an example, in which the upper part and the sides of the keyway shaping element 16k have protruding portions 17f, 17j. Here, the protruding portion 17f corresponds to that of keyway shaping element 16f and the protruding portions 17j correspond to those of keyway shaping element 16j. In the assembled state as shown in FIG. 25, the keyway shaping element 16j is placed in the slot 6f of cap 10f and attached to the plug 20, so that the protruding portion 17f redefines the middle portion 21a of the keyway 21, and the protruding portions 17j redefine the return portions 21c, 21e of the keyway 21.

Instead of providing one single keyway shaping element 16k it is also possible to use more than one keyway shaping element. For instance, one may combine keyway shaping elements 16f and 16j and attach them by means of a cap 10f to the plug 20, which result in the same redefinition of the keyway as the keyway shaping element 16k. The thickness of the keyway shaping elements and the thickness of the slot 6f of cap 10f are adapted to each other such that more than one keyway shaping element can be placed in the slot 6f.

### Third Embodiment

In the first and second embodiments, keyway shaping elements are provided at the front end of the keyway 21. It is conceivable to provide one or more keyway shaping elements within the axial length of the keyway 21.

FIG. 26 shows an example, in which the plug 20 is provided with keyway shaping elements 16l, 16m which are arranged within the axial length of the plug 22. Here, the plug 20 is covered by a cap 10, which is free of a keyway shaping element and which has the passage 13a.

The plug 20 has side wings 21b′, 21d′. Side wing 21b′ defines the side portion 21b of the keyway 21 and side wing 21d′ defines the side portion 21d of the keyway 21. A keyway shaping element 16l, 16m is received in a blind hole 24 formed in a side wing 21b′, 21d′, see also FIG. 27.

A keyway shaping element 16l, 16m is a formed by a pin, which is fixed in a blind hole 24 e.g. by press-fitting. The fixation is such that a keyway shaping element 16l, 16m does not move relative to the plug 20 when the key shank 711 of a key is inserted into the plug 20. In the assembled state, the front end of a keyway shaping element 16l, 16m forms a protruding portion 17l, 17m which protrudes into the keyway 21 and thereby redefines its geometry.

The length of a keyway shaping element 16l, 16m, its position along the plug 20 and the shape of the protruding portion may vary. FIG. 28 shows examples, in which the keyway shaping element 16l has a conical protruding portion 17l, the keyway shaping element 16m has a spherical protruding portion 17m, and the keyway shaping element 16n has a circular cylindrical protruding portion 17n

A key 70l, which is useable with a lock of FIG. 26, has a key shank 71l including at least one groove 78l, 78m for engagement with the at least one keyway shaping element 17l, 17m. In the example shown in FIGS. 29 and 30 the key shank 71l of the key 70l has grooves 78l, 78m which are formed on the side portions 73l, 75l of the key shank 71l. The cross-section of the groove 78l, 78m corresponds to the shape, which the corresponding keyway shaping element 17l, 17m has when seen in a side view. Here, the groove 78l has a triangular cross-section for engagement with the conical keyway shaping element 17l and the groove 78m has a circular cross-section for engagement with the spherical keyway shaping element 17m.

A groove configured to cooperate with the keyway shaping element 17n of FIG. 28 would have a rectangular cross-section.

The length of a groove 78l, 78m is adapted to the position of a keyway shaping element 17l, 17m along the plug 20. When the key shank 71l is fully inserted into the keyway 21, a keyway shaping element 17l, 17m will be positioned at the closed end of the groove 78l, 78m.

Alternatively or in addition to the provision of one or more grooves 78l, 78m it is also conceivable to change the profile geometry of the key shank. The plug 20 of FIG. 31 has side wings 21b′ and 21d′, which enclose an angle of A0, see FIG. 32.

Both side wings 21b′, 21d′ are provided with keyway shaping elements 16o. A keyway shaping element 16o has a protruding portion 17o and may e.g. have the shape of the keyway shaping element 16m.

The keyway shaping elements 16o protrude into the keyway 21, so that a side wing 21b′, 21d′ and the top of a protruding portion 17o enclose an angle of A1, see FIG. 32. Accordingly, the angle B between the top of a keyway shaping element 17o on wing 21b′ and the top of a keyway shaping element 17o on wing 21d′ is reduced twice by the angle A1 with respect to the angle A0: B=A0−2·A1.

In accordance with the provision of the angle B between the keyway shaping elements 17o, a key useable with a plug 20 of FIG. 31 has a key shank 71o with side portions 73o, 75o, which are inclined to each other by the reduced angle of B.

Other embodiments are conceivable which change the profile geometry of the key shank. In the example of FIG. 32, the plug may e.g. provided with keyway shaping elements 17o on only one wing 21b′ or 21d′, so that the reduced angle is given by A0-A1. In another example, the size with which the protruding portions of the keyway shaping elements 17o extend into the keyway 21 may be different on wings 21b′ and 21d′. Accordingly, the angle A1 shown in FIG. 32 may be different on both sides, e.g. the angle may correspond to A1 on the left-hand side and to A1′ on the right-hand side. In this case the reduced angle is given by A0-A1-A1′.

The embodiments described herein allow the provision of a master and slave lock system. For instance a lock according to FIG. 4 may be a master lock, which can be operated by the key of FIG. 5. A lock which is configured the same as the one of FIG. 4, but without the keyway shaping element 16a may be considered as a slave lock, which can also be operated by the key of FIG. 5. However, a key having a key shank as the key of FIG. 5, but without the grooves can operate only the slave lock, but not the master lock, as due to the missing grooves the key shank cannot be inserted in the keyway of the master lock.

The embodiment as shown in FIG. 32 may define a master lock and the lock of FIG. 32 without the keyway shaping elements 17o may define a slave lock. The key 710 of FIG. 32, which has side portions 73o, 75o inclined to each other by the angle B, may be used to operate said master and said slave lock, whereas a key having side portions inclined to each other by the angle A may be used to operate the slave lock only, but not the master lock.

From the preceding description, numerous modifications are accessible to one skilled in the art without departing from the scope of protection of the invention that is defined by the claims.

The keys described here have an arcuate middle portion, on both sides of which a U-shaped wall portion is attached. Other profiles are conceivable, in particular those as shown in FIGS. 11 to 46c of U.S. Pat. No. 9,920,548 B2, in FIGS. 14 to 17 of WO 2016/162363 A1 and in FIG. 13 of WO 2018/041277 A1 of the same applicant. In general, the key shank may at least in a part of its axial length include a profile which is closed or semi-closed to define at least one cavity including a key coding.

The key shank with the key coding may be manufactured in one piece. The at least one cavity is formed such that the key coding is at least in part invisible from outside. The profile may have a shape which is different from a U-shape.

1. A lock configured to be operated by a key, the key comprising a key shank, which at least in a part of its axial length includes a profile which is closed or semi-closed to define at least one cavity including a key coding,
the lock comprises:
a plug for receiving the key shank and being configured to be accommodated in a housing, the plug being rotatable with respect to the housing in the unlocked state of the lock, the plug including a keyway, which is defined by a predetermined geometry,
and at least one keyway shaping element, which is formed separate from the plug and is fixed to the plug such that it is immovable relative to the plug when the key shank is inserted into the plug, a protruding portion of the at least one keyway shaping element protrudes into the keyway to redefine its geometry.

2. The lock according to claim 1, wherein the protruding portion of the at least one keyway shaping element extends in an axial direction of the keyway less than an axial extent of the keyway, preferably the axial extent of the protruding portion is less than the extent of the protruding portion transversally to the axial direction.

3. The lock according to claim 1, wherein the at least one keyway shaping element is arranged at the forward end of the plug or within the axial length of the plug.

4. The lock according to claim 1, which comprises further at least one of the following features A1 to A3:
A1) a cap configured to cover the front end of the plug, the at least one keyway shaping element being attached to the cap,
A2) an axle which is fixed to the plug, the at least one keyway shaping element having a hole for attachment to the axle,
A3) a blind hole formed in the plug, a part of the at least one keyway shaping element being received in the blind hole.

5. The lock according to claim 1, wherein said protruding portion of the at least one keyway shaping element has at least in part one of the following shapes:
a shape including one or more teeth,
a polygonal shape,
a shape curved in one or more directions,
a conical shape,
a spherical shape, and
a circular cylindrical shape.

6. The lock according to claim 1, wherein the at least one keyway shaping element is formed by a bent ribbon, by a plate having an edge, which defines said protruding portion, or by a pin.

7. The lock according to claim 1, wherein the keyway has a transverse keyway profile which includes an arcuate portion, preferably the keyway includes at least one side portion adjacent to the arcuate portion, most preferably the keyway includes at least one return portion adjacent to the at least one side portion.

8. The lock according to claim 7, wherein said protruding portion of the at least one keyway shaping element protrudes into the arcuate portion, the at least one side portion and/or the least one return portion of the keyway profile.

9. The lock according to claim 1, which comprises at least two keyway shaping elements, each being formed separate from the plug and fixed to the plug such that they are immovable relative to the plug when the key shank is inserted into the plug, the protruding portions of said at least two keyway shaping elements protrude into the keyway to redefine its geometry at different locations, preferably said at least two keyway shaping elements being arranged at the same axial position along the axial direction of the keyway or being arranged offset to each other along the axial direction of the keyway.

10. The lock according to claim 1, which comprises further at least one of the following features B1 to B3:
B1) at least one validating element configured to cooperate with the key introduced into the plug to read the key coding, preferably the at least one validating element is movably arranged in a plane transversally to the rotation axis around which the plug is rotatable when the lock is in the unlocked state, most preferably the at least one validating element is rotatable around the rotation axis,
B2) at least one blocking bar, which, in the locked state of the lock, engages into a longitudinal groove formed in the housing and which, in the unlocked state of the lock, is receivable in a receiving space in the plug,
B3) a housing to accommodate the plug such that the plug is rotatable relative thereto, preferably the housing defining a portion of the geometry of the keyway, most preferably said portion being defined by a curved wall portion of the housing.

11. A lock system comprising at least one lock according to claim 1 and at least one key to operate said at least one lock.

12. The lock system according to claim 11, wherein the key shank of the at least one key includes a wall portion, which, seen in a plane transverse to the longitudinal direction in which the key shank extends, has a shape complementary to the protruding portion of the at least one keyway shaping element.

13. The lock system according to claim 11, wherein the key shank of the at least one key includes at least one groove to cooperate with the protruding portion of the at least one keyway shaping element.

14. The lock system according to claim 11, wherein the profile of the key shank defining the at least one cavity includes an arcuate wall portion, preferably the profile includes at least one side wall portion connected to the arcuate wall portion, most preferably the profile includes at least one return wall portion connected to the at least one side wall portion.

15. The lock system according to claim 11, further comprising at least a second lock, which is configured to be operated by said at least one key, said at least second lock corresponds to the at least one lock without the at least one keyway shaping element.

16. A method for manufacturing a lock according to claim 1, including the steps of:
providing a plug, which includes a keyway being defined by a predetermined geometry, and
attaching at least one keyway shaping element to the plug so that a portion of the at least one keyway shaping element protrudes into the keyway to redefine its geometry, the attachment of the at least one keyway shaping element to the plug being such that it is immovable relative to the plug when the key shank is inserted into the plug.
